(19) United States
(12) Patent Application Publication
(10) Pub. No.: US 2004/0181301 A1
(43) Pub. Date: Sep. 16, 2004

(54) Sound information output control circuit and display unit provided with same

(76) Inventors: Toru Kimura, Takefu-city (JP); Koji Tsubota, Takefu-city (JP); Eiji Yasuda, Takefu-city (JP)

Correspondence Address: FLYNN THIEL BOUTELL & TANIS, P.C., 2026 RAMBLING ROAD, KALAMAZOO, MI, 49008-1699, US

(21) Appl. No.: 10/796,813

(22) Filed: Mar. 9, 2004

(30) Foreign Application Priority Data
Mar. 12, 2003 (JP) 2003-066810

(51) Int. Cl. G06F 17/00

(52) U.S. Cl. 700/94

(57) ABSTRACT

An object of the invention is to provide a sound information output control circuit for outputting only sound information selected in the case where digital information or analog information is outputted as sound, from a speaker, thereby preventing sound from being outputted doubly and reducing the power consumption, and a display unit having the sound information output control circuit. A sound information conversion circuit, a sound information changeover circuit, a sound information adjustment circuit and an amplifier are grounded via switch circuits, and a D/A converter and an amplifier are grounded via a switch circuit. The switch circuits are connected to the CPU, and they are to turn ON or OFF in response to a signal from the CPU. When one of these switch circuits is allowed to turn ON appropriately in response to the signal from the CPU based on a selected sound output mode, thereby stopping the supply of power to a non-used circuit.

### FIELD OF THE INVENTION

The invention relates to a sound information output control circuit for processing and outputting digital information from DVDs (Digital Versatile Discs), CDs (Compact Discs) and so forth and analog information from TVs and so forth, for example, such as a television receiver provided with reproduction function of the DVDs and the CDs, and a display unit provided with the sound information output control circuit.

### BACKGROUND OF THE INVENTION

A high capacity information recording equipment such as DVDs, HDDs and so forth has recently come into practical use wherein image information and sound information are digitized and recorded, then they are displayed on monitors such as CRTs and so forth. Since the TVs have been already come into wide use in homes, there has been developed a combined unit combined with functions for reproducing such digitized image information and sound information by the conventional TV receiver.

In such a combined unit, since it is necessary to output sound information together with conventional analogized sound information, the number of speakers to be connected to the combined unit associated therewith increases, thereby needing the control of output of the information to the speakers. For example, in the reference 1 of JP-A 10-191203, there is described that low sound intensity is effected by a low sound intensity circuit even if the changeover switch selects either a center channel signal input terminal or an L/R sound signal input terminal, so as to efficiently utilize a low sound intensity circuit and a sub-woofer built in a TV receiver in the case where the left and right speakers built in the TV receiver are used as a center speaker of Dolby pro-logic or Dolby digital center speaker. Further, there has been described a sound output changeover circuit in the reference 2 of JP-A 2001-309499, wherein in the TV receiver building therein two left and right speakers and a third speaker, in the case where two-channel sound information is inputted, sound information formed by composing the sound information from the two channels is outputted to the third speaker, while in the case where 5.1 channel sound information is inputted, the same information is automatically discriminated and only information assigned to the third speaker is outputted to the third speaker.

According to the conventional technical references, although an output of sound information is controlled on the premise of the use of the speaker built in the TV receiver, since the digitized sound information is large in amount of data compared with analogized sound information of TVs and so forth, and can output more high quality sound, it is possible to satisfy high quality sound by use of an external speaker having high performance compared with the built-in speaker by connecting the external speaker to the TV receiver.

However, in the aforementioned conventional TV receiver, when the external speaker is used by connecting to the TV receiver, sound is also outputted from the built-in speaker. In such a manner, if the sound is outputted doubly, the high quality sound from the external speaker is diminished in quality by the sound from the built-in speaker.

Accordingly, it is an object of the invention to provide a sound information output control circuit capable of preventing sound from being outputted doubly and reducing power consumption by outputting only selected sound information when outputting digitalized sound information or analogized sound information, and a display unit provided with the sound information output control circuit.

### SUMMARY OF THE INVENTION

The sound information output control circuit of the invention is characterized in comprising digital information generation means for generating digitized sound information, analog information generation means for generating analogized sound information, selection means for outputting a selection signal for outputting either the sound information of the digital information generation means or analog information generation means and power supply control means for stopping the supply of power to the generation means which has not been selected in response to the selection signal from the selection means. Further, the digital information generation means is characterized in reproducing the sound information from information recorded in DVDs or CDs. Still further, the analog information generation means is characterized in that the sound information is reproduced from a television receiving signal.

Still further, the display unit of the invention provided with the aforementioned sound information output control circuit is characterized in further comprising built-in speakers for outputting sound information from the analog information generation means, a first external output terminal for outputting the sound information from the analog information generation means, and a second external output terminal for outputting the sound information from the digital information generation means. Further, the selection means comprises means for displaying the selected items on a screen and means for outputting the selection signal based on operation information of an operator associated with the selected items.

With the sound information output control circuit having such a configuration, since the sound is outputted from only the generation means selected by the selection means, the sound is not outputted doubly. Accordingly, the digitized sound information can be outputted from the external speaker, thereby satisfying the high quality sound. Further, since the supply of power to the non-selected generation means is stopped not to output the sound information, the power is not supplied to the other generation means when one generation means outputs the sound information, thereby reducing the power consumption by the amount of non-supply of the power.

Further, in the case where the digitalized sound information is reproduced from the information recorded in DVDs or CDs, high quality image and high quality sound are outputted based on the sound information from the external speaker, so that the DVDs or the CDs can exert the merits thereof sufficiently. In the case where the analogized sound information is outputted from the television receiving signal, the supply of power to the digital information generation means is stopped during the outputting of the sound of the television, thereby enhancing the reduction of power consumption.

Even in the display unit provided with the built-in speakers for outputting the sound information and the external output terminals, in the case where the built-in speakers are not used, the sound is not outputted and the power is not supplied to the analog information generation means, and in the case where the external speaker is not connected even to the external output terminal for outputting the sound information from the digital information generation means, the power is not supplied to the digital information generation means. Further, in the display unit, when the selection means displays the selected item on a screen to output the selected information by the operation of an operator, the sound meeting the need of the operator can be outputted.

### PREFERRED EMBODIMENT OF THE DRAWINGS

FIG. 1 is an entire block diagram showing a display unit of the invention;

FIG. 2 is a block diagram showing a sound information output control circuit of the invention;

FIG. 3 is a view for explaining an output mode of sound information;

FIGS. 4(A) and 4(B) are views for explaining transition of an operation screen; and

FIG. 5 is a flow chart showing a processing of an output control of the sound information.

### PREFERRED EMBODIMENT OF THE INVENTION

The embodiment of the invention is now described more in detail. Since the embodiment described hereinafter is a preferred embodiment for carrying out the invention, it has been variously limited in technical point of view, but the invention is not limited to this embodiment unless there is a description to limit the invention.

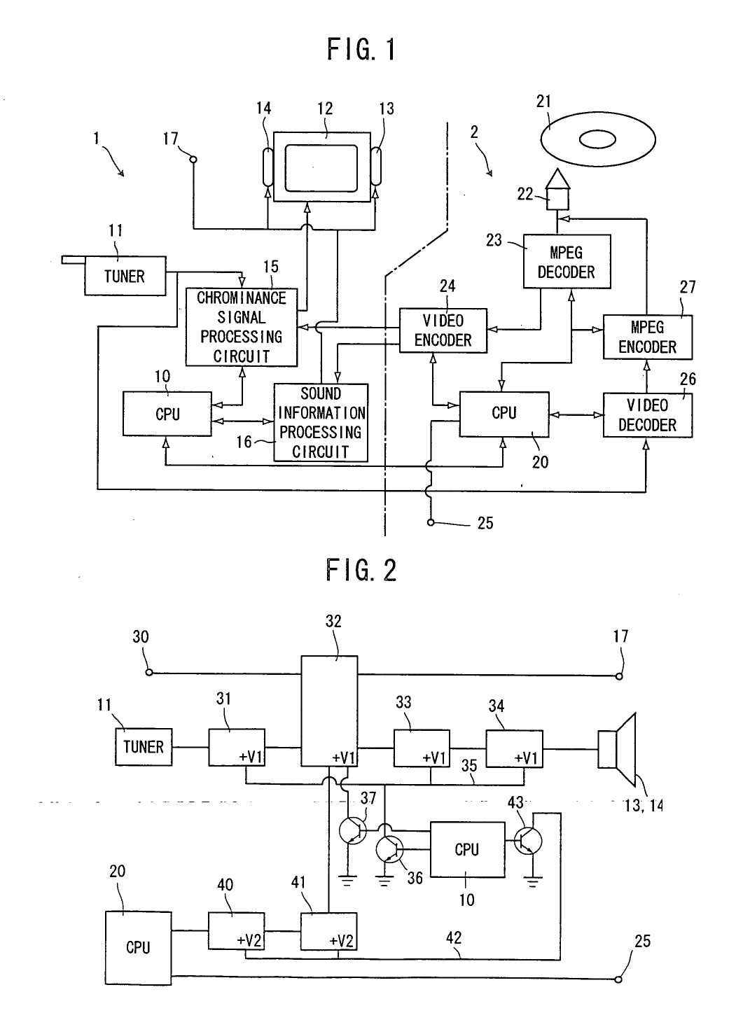

FIG. 1 is an entire block diagram showing a display unit provided with a sound information output control circuit of the invention. A display unit body 1 comprises a CPU 10 for executing information processing relating to an entire control, a tuner 11 for receiving a television signal from an external device, a monitor 12 for displaying image, left and right speakers 13 and 14 built in the monitor 12. An output signal from the tuner 11 is processed by a chromatograph signal processing circuit 15 whereby image information is transmitted to the monitor 12 and controlled in display while sound information is transmitted from the CPU 10 to a sound information processing circuit 16 and sound thereof is outputted from the left and right speakers 13 and 14. An external output terminal 17 is connected to the sound information processing circuit 16, wherein if an externally provided sound output unit is connected to the external output terminal 17 the analogized sound information is externally outputted.

Meanwhile, a DVD reproducer 2 is provided together with the display unit body 1 and the DVD reproducer 2 has a CPU 20 for DVD for executing information processing relating to the reproduction control. Information recorded in a disc 21, which is rotated by a rotation controller, not shown, is read by a pickup 22 and the read information is decoded by an MPEG decoder 23. Since the decoded information is digital information, it is analogized by a video encoder 24 and supplied to the chrominance signal processing circuit 15 and the sound information processing circuit 16, and displayed on the monitor 12 of the display unit body 1 as image and outputted by built-in speakers 13, 14 as sound. An external output terminal 25 is connected to the CPU 20 for DVD, wherein if the externally provided sound output unit and the external output terminal 25 are connected to each other, the digitalized sound information is externally outputted.

Incidentally, although the DVD reproducer 2 is provided together with the display unit body 1, a CD reproducer can be provided together with the display unit body 1 instead thereof. In such a case, it is sufficient that a circuit configuration may be changed such that the CPU 20 for DVDs is substituted by a CPU for CDs, and so forth.

Further, it is possible that a video decoder 26 at the side of the DVD reproducer 2 is connected to the tuner 11, and the analog signal received by the tuner 11 is converted into the digital signal, then it is compressed by an MPEG encoder 27, subsequently, the compressed signal is subjected a processing to be recorded in the disc 21 by the pickup 22.

FIG. 2 is a block diagram showing the sound information output control circuit. A signal received by the tuner 11 is converted into a signal by a sound information conversion circuit 31, and inputted to a sound information changeover circuit 32. An external input terminal 30 is connected to the sound information changeover circuit 32, thereby inputting sound information from the outside. The sound information outputted from the sound information changeover circuit 32 is adjusted by a sound information adjustment circuit 33, then it is amplified by an amplifier 34 and outputted from the left and right speakers 13, 14. The external output terminal 17 is connected to the sound information changeover circuit 32 wherein the externally provided sound output unit as set forth above is connected to the external output terminal 17 to output sound.

Meanwhile, the sound information read from the DVD is transmitted from the CPU 20 for DVD to a D/A converter 40 where it is analogized. The analogized sound information is amplified by an amplifier 41 and inputted to the sound information changeover circuit 32. Subsequently, the sound information is processed in the same manner as a case from the tuner 11, and outputted from the built-in speakers 13, 14 as sound. The external output terminal 25 is connected to the CPU 20 for DVD and the externally provided sound output unit is connected to the external output terminal 25 to output sound.

A power supply line 35 connected to the sound information conversion circuit 31, the sound information adjustment circuit 33 and the amplifier 34 is grounded via a switch circuit 36, and the sound information changeover circuit 32 is also grounded via a switch circuit 37. A power supply line 42 connected to a D/A conversion circuit 40 and the amplifier 41 is grounded via a switch circuit 43. The switch circuits 36, 37 and 43 are connected to the CPU 10, and they turn ON or OFF in response to a signal from the CPU 10. When the switch circuit 36 turns ON in response to the signal from the CPU 10, the power supply line 35 becomes a ground potential to stop the supply of power to the sound information conversion circuit 31, the sound information adjustment circuit 33 and the second motor 34. Even in the case of the sound information changeover circuit 32, when the switch circuit 37 turns ON, the supply of power to the sound information changeover circuit 32 is stopped. Further, when the switch circuit 43 turns ON in response to the signal from the CPU 10, the power supply line 42 becomes a ground potential to stop the supply of power to the D/A conversion circuit 40 and the amplifier 41.

Accordingly, in the case where the sound information is outputted upon reception of the signal from the tuner 11, if the switch circuits 36 and 37 turn OFF and the switch circuit 43 turns ON, the power is not supplied to circuits at the DVD reproducer side, to reduce the power consumption by that amount. Further, in the case when the DVD is reproduced to transmit the sound information from the external output terminal 25 to an external output unit, the switch circuits 36, 37 and 43 turn ON, so that the sound is not outputted from the built-in speakers 13, 14 because the power is not supplied to a circuit of the display unit body 1, thereby preventing the sound from being outputted doubly from the external output unit and the built-in speakers 13, 14, and further, the power supply is stopped, thereby reducing the power consumption. If the switch circuit 36 alone turns ON, although the sound is not outputted from the built-in speakers 13, 14, there becomes a state where the sound information is outputted to the external output terminals 17 and 25.

According to the explanation set forth above, although a plurality of circuits turn ON or OFF at the same time by a single switch circuit, it is no problem that switch circuits are provided for every circuit to turn ON or OFF individually.

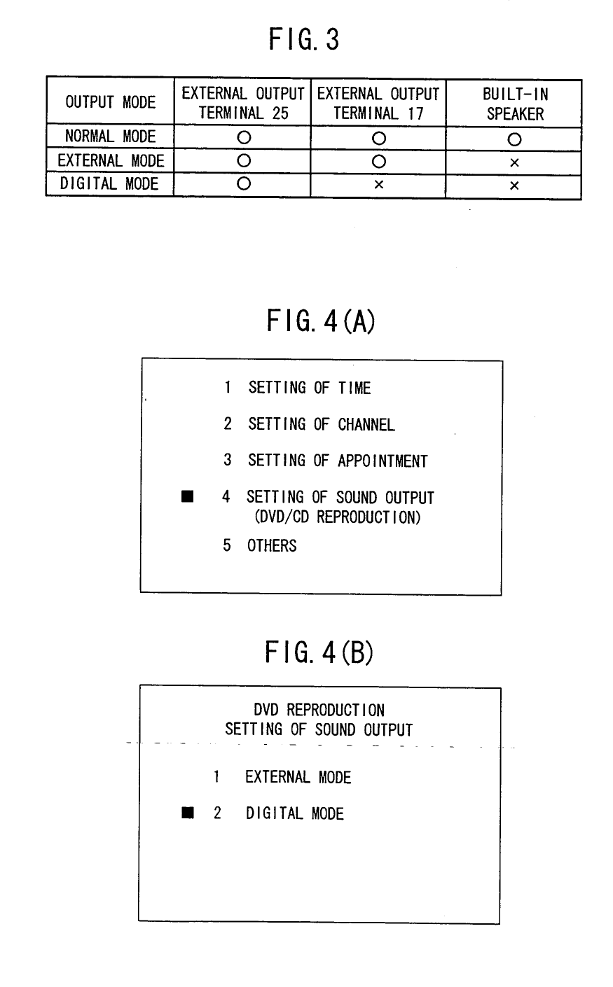

Described next is an example of a selection flow of the output of sound information. First of all, three modes are set in advance as shown in FIG. 3. In a normal mode, all the sound information are outputted to the built-in speakers 13, 14, the external output terminal 17 and the external output terminal 25 in a state where all the switch circuits 36, 37 and 43 turn OFF. In an initial setting, this normal mode is selected. In an external mode, the sound information is not supplied to the built-in speakers 13, 14 (the switch circuit 36 turns ON), but it is supplied to the external output terminal 17 and the external output terminal 25 (the switch circuit 43 turns OFF). In a digital mode, the sound information is not supplied to the built-in speakers 13, 14 and the external output terminal 17 (the switch circuits 36 and 37 turn ON) but it is supplied to the external output terminal 25 (the switch circuit 43 turns ON).

FIGS. 4(A) and 4(B) are views for explaining transition of a screen when displaying a menu screen and effect selection. In the initial menu screen shown in FIG. 4(A), a sound output setting is provided as a selection item, wherein if this item is selected, a sub-menu shown in FIG. 4(B) appears. On the sound output setting screen, either the external mode or the digital mode has to be selected and controlled in the manner that if the external mode is selected, the sound information is outputted to the external output terminal 17 and the external output terminal 25, while if the digital mode is selected, the sound information is outputted only to the external output terminal 25. With such an operation of selection, the CPU 10 outputs the selection signal to store it in the storage portion.

Incidentally, the thus set output mode may be displayed such that an identifying mark is always displayed on the screen of the monitor. For example, when the digital mode is selected, it is sufficient that “D” may be displayed. Further, when the screen is switched to the receiving screen from the tuner 11 when the DVD is reproduced, the setting screen is displayed to erase the selection information to return to the initial setting.

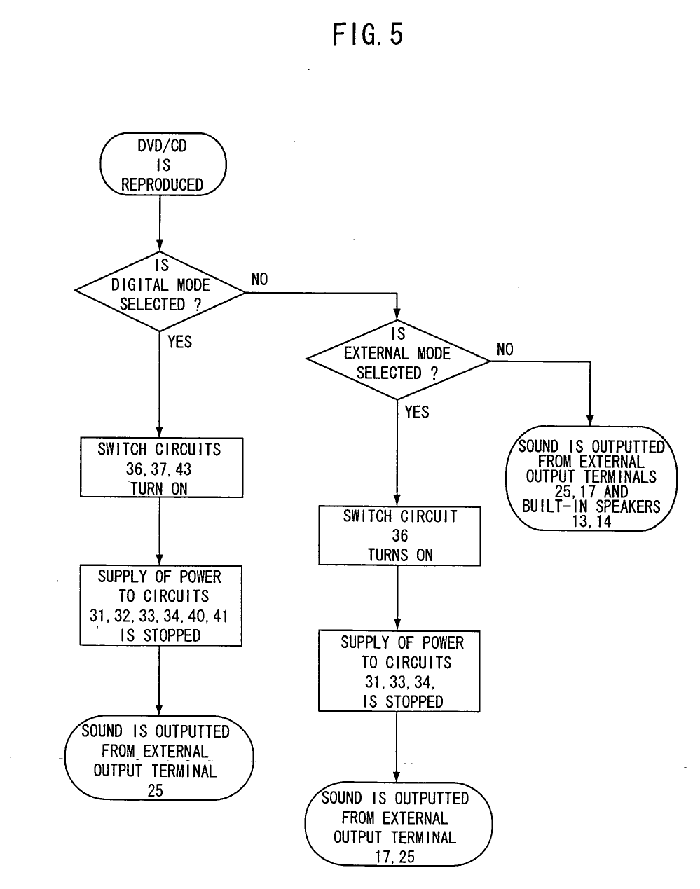

FIG. 5 is a flow chart showing an example of processing for controlling the output of the sound information based on the thus selected information. A normal mode is set as an initial setting. When the DVD reproduction mode starts (step S100), the CPU 10 first checks the selection signal to check as to whether the selection mode is selected (step S101), and if the digital mode is selected, a signal is outputted (step S102) so as to turn ON the switch circuits 36, 37 and 43. When the switch circuits 36, 37 and 43 turn ON, the supply of power to the sound information conversion circuit 31, the sound information changeover circuit 32, the sound information adjustment circuit 33, the amplifier 34, the D/A conversion circuit 40 and the amplifier 41 is stopped (step S103) so that only the external output terminal 25 can output the sound information (step S104).

In the case where the digital mode is not selected in step S101, the CPU 10 checks the selection signal as to whether the external mode is selected or not (step S105), and if the external mode is selected, a signal for turning ON the switch circuit 36 is outputted (step S106). If the switch circuit 36 turns ON, the supply of power to the sound information conversion circuit 31, sound information adjustment circuit 33 and the amplifier 34 is stopped (step S107) so that the external output terminals 17 and 25 can output the sound information.

If the external mode is not selected in step S105, the initial setting (the switch circuits 36, 37 and 43 are turn OFF) remains as it is as the normal mode (step S109).

What is claimed is:

1. A sound information output control circuit comprising:
digital information generation means for generating digitized sound information;
analog information generation means for generating analogized sound information;
selection means for outputting a selection signal for outputting either the sound information of the digital information generation means or analog information generation means; and
power supply control means for stopping the supply of power to the generation means which has not been selected in response to the selection signal from the selection means.

2. The sound information output control circuit according to claim 1, wherein the digital information generation means reproduces the sound information from information recorded in DVDs or CDs.

3. The sound information output control circuit according to claim 1, wherein the analog information generation means reproduces the sound information from a television receiving signal.

4. A display unit provided with the sound information output control circuit disclosed according to claim 1, said display unit further comprising:
built-in speakers for outputting sound information from the analog information generation means,
a first external output terminal for outputting the sound information from the analog information generation means; and
a second external output terminal for outputting the sound information from the digital information generation means.

5. The display unit according to claim 4, wherein the selection means comprises means for displaying the selection items on a screen and means for outputting the selection signal based on operation information of an operator associated with the selection items.
